(19) United States
(12) Patent Application Publication
(10) Pub. No.: US 2025/0257935 A1
(43) Pub. Date: Aug. 14, 2025

(54) Modular Cooler System

(71) Applicant: Brian Keith McKinnon, Anchorage, AK (US)

(72) Inventor: Brian Keith McKinnon, Anchorage, AK (US)

(21) Appl. No.: 19/049,381

(22) Filed: Feb. 10, 2025

Related U.S. Application Data
(60) Provisional application No. 63/551,547, filed on Feb. 9, 2024.

(51) Int. Cl. F25D 25/00; F25D 3/08

(52) U.S. Cl. CPC F25D 25/005; F25D 3/08; F25D 2201/10; F25D 2300/00; F25D 2331/804

(57) ABSTRACT

A modular cooler assembly having a plurality of cooler or other storage components, which may or may not be insulated, each component defining an interior storage space and an exterior surface and at least one connector configured to removably interconnect adjacent cooler components, wherein the connector includes a first engagement portion attached to a first cooler component and a second engagement portion attached to a second cooler component wherein the plurality of cooler components are configured to be arranged in multiple configurations based on user preference while maintaining thermal insulation of the interior storage space of each cooler component.

### CROSS REFERENCE TO RELATED APPLICATIONS

This application claims priority to U.S. Provisional Patent Application No. 63/551,547 filed on Feb. 9, 2024 and entitled Modular Cooler System, which is hereby incorporated by reference.

### TECHNICAL FIELD

The present specification generally relates to a modular cooler and/or storage system. More specifically, the present specification relates to a cooler system having a modular components and fasteners.

### BACKGROUND

Coolers are well known in the art. However, typical coolers lack the abilities to process food, such as fish, and store said food in an airtight and/or modular configuration.

U.S. Pat. No. 5,457,939 discusses a process for vacuum-packaging foodstuffs in rigid containers wherein desired quantity of foodstuff to be packaged is placed in the container, a quantity of aqueous liquid in an amount sufficient to generate, when boiled, a volume of vapor sufficiently in excess of the volume of the container to substantially completely displace all other gases from the container, is added. The container is closed but not sealed, so as to permit communication between the interior of the container and the ambient atmosphere. The container and its contents are warmed to a temperature sufficient to generate the volume of vapor when the container is subjected to a pressure lower than atmospheric pressure. The temperature is kept as low as possible so that no cooking of the foodstuffs occurs. After warming, the containers are exposed to a low pressure so that the liquid in the container boils. The boiling liquid generates vapor in the container sufficient to drive out and displace other gases from the container. The container is hermetically sealed while exposed to the sub-atmospheric pressure.

While the cited prior art discusses the process of vacuum packaging foodstuffs in rigid containers wherein desired quantity of foodstuff to be packaged is placed in the container, a quantity of aqueous liquid in an amount sufficient to generate, when boiled, a volume of vapor sufficiently in excess of the volume of the container to substantially completely displace all other gases from the container, is added. The container is closed but not sealed, so as to permit communication between the interior of the container and the ambient atmosphere. The container and its contents are warmed to a temperature sufficient to generate the volume of vapor when the container is subjected to a pressure lower than atmospheric pressure. The temperature is kept as low as possible so that no cooking of the foodstuffs occurs. After warming, the containers are exposed to a low pressure so that the liquid in the container boils. The boiling liquid generates vapor in the container sufficient to drive out and displace other gases from the container. The container is hermetically sealed while exposed to the sub-atmospheric pressure, but the present invention is a non-powered cooler system with an integrated powered vacuum sealer wherein the outer body may be made up of a hard casing of hard plastic material or soft waterproof material. The cooler system as disclosed in the present invention is portable light weighted and suited to be carried during travels and for the preservation of the perishable material such as food, fish, vegetables, etc.

U.S. Pat. No. 7,930,892 talks about refrigerator with continuous vacuum insulation wherein a refrigerator includes a refrigerator housing, a refrigerated compartment disposed within the refrigerator housing, and a hollow refrigerator wall having insulation material therein. There is a first fluid connection from the vacuum pump to the hollow refrigerator wall for providing a first function of evacuating air from the hollow refrigerator wall and a second fluid connection from the vacuum pump for providing a second function of evacuating air.

None of the prior art discloses a modular system allowing multiple cooler portions and accessories to connect thereto and together.

### SUMMARY

The present invention is a non-powered cooler system with modular components wherein the outer body may be made up of a hard casing of hard plastic material or soft waterproof material. The cooler system as disclosed in the present invention is portable light weighted and suited to be carried during travels and for the preservation of the perishable material such as food, fish, vegetables, etc. or other goods not requiring refrigeration. The connectable modular components include at least the following:
Live fish well
Different size long term battery packs
Digital scale
Gold dredge
Sump pump
Dehumidifier box to dry gear and other products
Battery operated coffee machine
Tool box
Portable stove
Fold out sink
Compartment for dishware and cooking utensils
Fold up chairs
Back rests that turn the cooler into a bench
Fire pit
Startlink
Powered coolers (fridge and freezer that can be built into what ever configuration you want
Response kit
Survival kit
MRE style meal kit
Tent
Inflatable personal packraft
Probable heater
Sleeping bag holster
Kit to hold filet knife, sharpener and sealer bags for batter operated vacuum sealer
Boot dryer
Ice fishing tent
Rod holders
Rod cases
Ammo can
Shot platform table
Tackle box
Tree stand
Dog kennel
Gas cans
Portable water turbine for charging
Portable wind turbine for charging
Table that is solar panel for charging
Ice maker
Gun case
Duck blind
Top storage bin instead of table that also connects to top of car
Backpack
Battery operated meat grinder
Different size battery operated vacuum sealers
Blow up mattress
Cot
Filtered water storage
Non filtered water storage
Lantern
Generator
Jet boil kit
Battery operated blender
Beach and party games
Dj set up
Fish finder
Speakers
Pizza oven
Food warming container

In one general aspect, reference may include While particular embodiments have been illustrated and described herein, it should be understood that various other changes and modifications may be made without departing from the spirit and scope of the claimed subject matter. Reference may also include Moreover, although various aspects of the claimed subject matter have been described herein, such aspects need not be utilized in combination. Reference may furthermore include It is therefore intended that the appended claims (and/or any future claims filed in any utility application) cover all such changes and modifications that are within the scope of the claimed subject matter. Reference may in addition include Moreover, although various aspects of the claimed subject matter have been described herein, such aspects need not be utilized in combination. Reference may moreover include It is therefore intended that the appended claims cover all such changes and modifications that are within the scope of the claimed subject matter. Reference may also include. Other embodiments of this aspect include corresponding computer systems, apparatus, and computer programs recorded on one or more computer storage devices, each configured to perform the actions of the methods.

In one general aspect, modular storage assembly may include a plurality of storage components, each storage component defining an interior storage space and having an exterior surface. Modular storage assembly may also include at least one connector configured to removably interconnect adjacent storage components, where the connector includes: a first engagement portion attached to a first storage component; a second engagement portion attached to a second storage component; and a rotating latch having a handle, the rotating latch being configured to pivot between a locked position, where the first and second engagement portions are secured together, and an unlocked position, where the first and second engagement portions are disengaged. Assembly may furthermore include where the plurality of storage components are configured to be arranged in multiple configurations based on user preference. Other embodiments of this aspect include corresponding computer systems, apparatus, and computer programs recorded on one or more computer storage devices, each configured to perform the actions of the methods.

Implementations may include one or more of the following features. Modular storage assembly where the storage components are insulated. Implementations of the described techniques may include hardware, a method or process, or a computer tangible medium.

In one general aspect, modular storage assembly may include a plurality of storage components, each storage component defining an interior storage space and having an exterior surface. Modular storage assembly may also include at least one connector configured to removably interconnect adjacent storage components, where the connector includes: a first engagement portion attached to a first storage component; a second engagement portion attached to a second storage component; and a buckle-like latch configured to secure the first and second engagement portions together. Assembly may furthermore include where the plurality of storage components are configured to be arranged in multiple configurations based on user preference.

Implementations may include one or more of the following features. Modular storage assembly where the storage components are insulated. Modular storage assembly where the storage components are not insulated.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts four perspective views of different embodiments of the cooler system including the tether, cam lever, buckle, and the dial embodiments according to one or more embodiments shown and described herein;

FIG. 2 depicts a perspective of one embodiment of the dial embodiment according to one or more embodiments shown and described herein;

FIG. 3 depicts a perspective of the table having hooks removable from the cooler base according to one or more embodiments shown and described herein;

FIG. 4 depicts the aperture for the hooks for the table as shown in FIG. 3 according to one or more embodiments shown and described herein;

FIG. 5 depicts a perspective view of the spring-loaded clips according to one or more embodiments shown and described herein;

FIG. 6 depicts a perspective view of the dial cooler according to one or more embodiments shown and described herein;

FIG. 7 depicts a perspective view of the dial cooler according to one or more embodiments shown and described herein;

FIG. 8 depicts a perspective view of the dial cooler according to one or more embodiments shown and described herein;

FIG. 9 depicts an exploded perspective view of one embodiment of the dial cooler according to one or more embodiments shown and described herein;

FIG. 10 depicts an exploded perspective view of one embodiment of the dial cooler according to one or more embodiments shown and described herein;

FIG. 11 depicts an exploded perspective view of one embodiment of the dial cooler according to one or more embodiments shown and described herein;

FIG. 12 depicts an exploded perspective view of one embodiment of the dial cooler according to one or more embodiments shown and described herein;

FIG. 13 depicts a dial embodiment cooler with a set of rails on the underside of the lids to allow quick attachment (and detachment of accessories) according to one or more embodiments shown and described herein;

FIG. 14 depicts a dial embodiment cooler with a set of rails on the underside of the lids to allow quick attachment (and detachment of accessories) according to one or more embodiments shown and described herein;

FIG. 15 depicts a perspective view of the dial embodiment cooler with wheels and a prop leg according to one or more embodiments shown and described herein;

FIG. 16 depicts a perspective view of the dial embodiment cooler with wheels according to one or more embodiments shown and described herein;

FIG. 17 depicts a close-up perspective view of the wheel detached according to one or more embodiments shown and described herein;

FIG. 18 depicts a close-up perspective view of the wheel attached according to one or more embodiments shown and described herein;

FIG. 19 depicts an embodiment of the cooler with stationary wheels and a fixed prop leg according to one or more embodiments shown and described herein;

FIG. 20 depicts a perspective view of a cooler with 4 wheels differing in size according to one or more embodiments shown and described herein;

FIG. 21 depicts a perspective view of a cooler with an endcap case connected thereto according to one or more embodiments shown and described herein;

FIG. 22 depicts a perspective view of the endcap only according to one or more embodiments shown and described herein;

FIG. 23 depicts a perspective view of a cooler with an endcap case connected thereto according to one or more embodiments shown and described herein;

FIG. 24 depicts a perspective view of a cooler of the present application having a base plate connection method according to one or more embodiments shown and described herein;

FIG. 25 depicts a perspective view of a cooler of the present application having a base plate connection method according to one or more embodiments shown and described herein;

FIG. 26 depicts a perspective view of a cooler of the present application having a base plate connection method according to one or more embodiments shown and described herein;

FIG. 27 depicts a perspective view of a cooler of the present application having a base plate connection method according to one or more embodiments shown and described herein;

FIG. 28 depicts a perspective view of a cooler of the present application having a base plate connection method according to one or more embodiments shown and described herein;

FIG. 29 depicts a perspective view of a cooler of the present application having a base plate connection method using metal lugs on the right side according to one or more embodiments shown and described herein;

FIG. 30 depicts a perspective view of a cooler of the present application having a base plate connection method using metal lugs on the right side according to one or more embodiments shown and described herein;

FIG. 31 depicts a perspective view of a cooler of the present application having a base plate connection method using metal lugs on the right side according to one or more embodiments shown and described herein;

FIG. 32 depicts a perspective view of a cooler of the present application having a base plate connection method using metal lugs on the right side according to one or more embodiments shown and described herein;

FIG. 33 depicts a perspective view of a cooler of the present application having a heavy duty panel base plate for connecting the modular cooler portions according to one or more embodiments shown and described herein;

FIG. 34 depicts a perspective view of a cooler of the present application having a heavy duty panel base plate for connecting the modular cooler portions according to one or more embodiments shown and described herein;

FIG. 35 depicts a side view of a cooler of the present application having a heavy duty panel base plate for connecting the modular cooler portions according to one or more embodiments shown and described herein;

FIG. 36 depicts a side view of a cooler of the present application having a heavy duty panel base plate for connecting the modular cooler portions according to one or more embodiments shown and described herein;

FIG. 37 depicts a side view of a cooler of the present application having a heavy duty panel base plate for connecting the modular cooler portions according to one or more embodiments shown and described herein;

FIG. 38 depicts a side view of a cooler of the present application having a heavy duty panel base plate for connecting the modular cooler portions according to one or more embodiments shown and described herein;

FIG. 39 depicts a perspective view of a cooler of the present application having a buckle connector connecting the modular cooler portions having a latch to secure the side of each cooler together according to one or more embodiments shown and described herein;

FIG. 40 depicts a close up perspective view of a cooler of the present application having a buckle connector connecting the modular cooler portions in an unlatched position having a latch to secure the side of each cooler together according to one or more embodiments shown and described herein;

FIG. 41 depicts a close up perspective view of a cooler of the present application having a buckle connector connecting the modular cooler portions in an unlatched position moving towards a latched position having a latch to secure the side of each cooler together according to one or more embodiments shown and described herein;

FIG. 42 depicts a close up perspective view of a cooler of the present application having a buckle connector connecting the modular cooler portions in an unlatched position moving towards a latched position having a latch to secure the side of each cooler together according to one or more embodiments shown and described herein;

FIG. 43 depicts a close up perspective view of a cooler of the present application having a buckle connector connecting the modular cooler portions in an unlatched position moving towards a latched position having a latch to secure the side of each cooler together according to one or more embodiments shown and described herein;

FIG. 44 depicts a close up perspective view of a cooler of the present application having a buckle connector connecting the modular cooler portions in an partially latched position having a latch to secure the side of each cooler together according to one or more embodiments shown and described herein;

FIG. 45 depicts a close up perspective view of a cooler of the present application having a buckle connector connecting the modular cooler portions in an partially latched position having a latch to secure the side of each cooler together according to one or more embodiments shown and described herein;

FIG. 46 depicts a close up perspective view of a cooler of the present application having a buckle connector connecting the modular cooler portions in an latched position having a latch to secure the side of each cooler together according to one or more embodiments shown and described herein;

FIG. 47 depicts a perspective view of a cooler of the present application having buckle latch for connecting the modular cooler portions having a latch to secure the side of each cooler together according to one or more embodiments shown and described herein;

FIG. 48 depicts a perspective view of a cooler of the present application having rotating dial latch for connecting the modular cooler portions having a latch to secure the side of each cooler together according to one or more embodiments shown and described herein;

FIG. 49 depicts a partially exploded perspective view of a cooler of the present application having rotating dial latch for connecting the modular cooler portions having a latch to secure the side of each cooler together according to one or more embodiments shown and described herein;

FIG. 50 depicts a perspective view of a cooler of the present application having rotating dial latch for connecting the modular cooler portions having a latch to secure the side of each cooler together according to one or more embodiments shown and described herein;

FIG. 51 depicts a perspective view of a cooler of the present application having rotating dial latch for connecting the modular cooler portions having a latch to secure the side of each cooler together according to one or more embodiments shown and described herein;

FIG. 52 depicts a perspective view of a cooler of the present application having rotating dial latch for connecting the modular cooler portions having a latch to secure the side of each cooler together according to one or more embodiments shown and described herein;

FIG. 53 depicts a perspective view of a cooler of the present application having an end cap for connecting to the modular cooler portions having a latch to secure the side of each cooler together according to one or more embodiments shown and described herein;

FIG. 54 depicts a perspective view of a cooler of the present application having an end cap for connecting to the modular cooler portions having a latch to secure the side of each cooler together according to one or more embodiments shown and described herein;

FIG. 55 depicts a perspective view of a cooler of the present application having an end cap for connecting to the modular cooler portions having a latch to secure the side of each cooler together according to one or more embodiments shown and described herein;

FIG. 56 depicts a perspective view of a cooler of the present application having an end cap for connecting to the modular cooler portions having a latch to secure the side of each cooler together according to one or more embodiments shown and described herein;

FIG. 57 depicts a perspective view of a cooler of the present application having an end cap for connecting to the modular cooler portions having a latch to secure the side of each cooler together according to one or more embodiments shown and described herein;

FIG. 58 depicts a perspective view of a cooler of the present application having an end cap for connecting to the modular cooler portions having a latch to secure the side of each cooler together according to one or more embodiments shown and described herein;

FIG. 59 depicts a front view of a modular cooler/storage system and assembly according to one or more embodiments shown and described herein; and

FIG. 60 depicts a front view of a modular cooler/storage system and assembly according to one or more embodiments shown and described herein.

### DETAILED DESCRIPTION

The present invention is a non-powered cooler system with modular components wherein the outer body may be made up of a hard casing of hard plastic material or soft waterproof material. The cooler system as disclosed in the present invention is portable light weighted and suited to be carried during travels and for the preservation of the perishable material such as food, fish, vegetables, etc. or other goods not requiring refrigeration. The connectable modular components are numerous and can vary according to the herein mentioned.

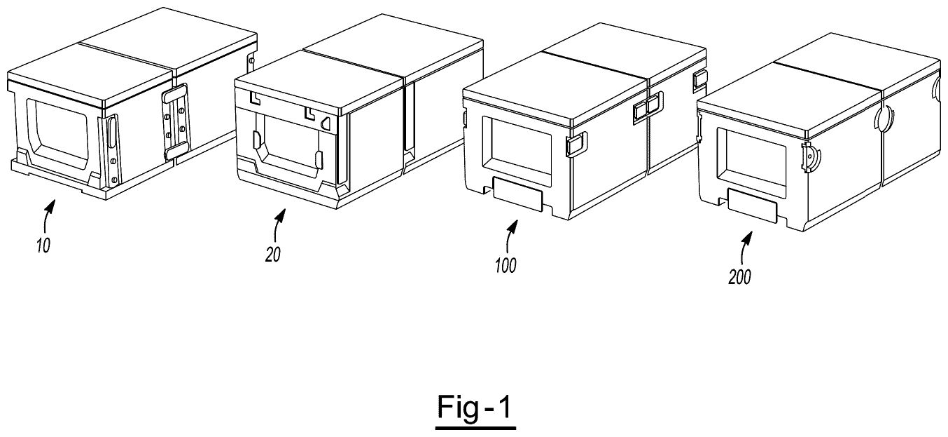

FIG. 1 depicts four perspective views of different embodiments of the cooler system including the tether, cam lever, buckle, and the dial embodiments according to one or more embodiments shown and described herein including a first embodiment 10, a second embodiment 20, a buckle embodiment 100, and a rotating latch embodiment 200.

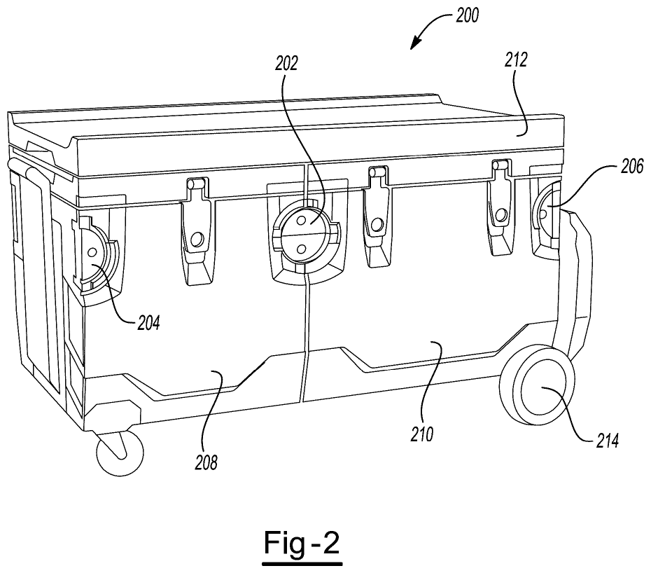

FIG. 2 depicts a perspective of one embodiment of the dial embodiment according to one or more embodiments shown and described herein. A cooler 200 includes a dial 202. Separate dials 204, 206 are provided on separate opposite ends. The components 208, 210 may be insulated or not insulated and may be traditional coolers or other components such as storage containers or other components such as those listed above. The rotatable dial 202 is rotatable to connect the components 208, 210 together to form a one piece assembly 200. A lid slash table 212 is provided. Wheels 214 are also provided connected to an underside of the assembly 200.

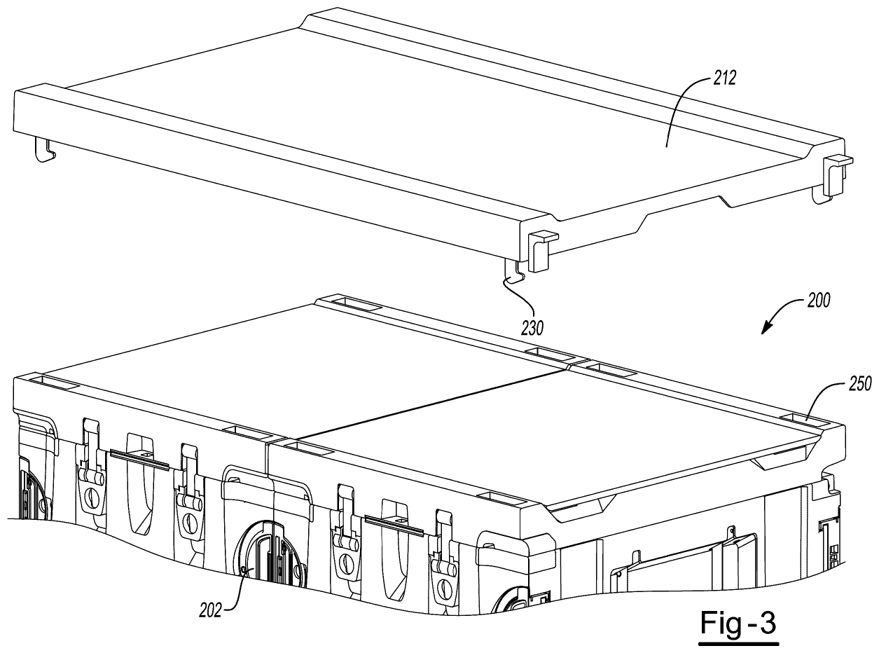

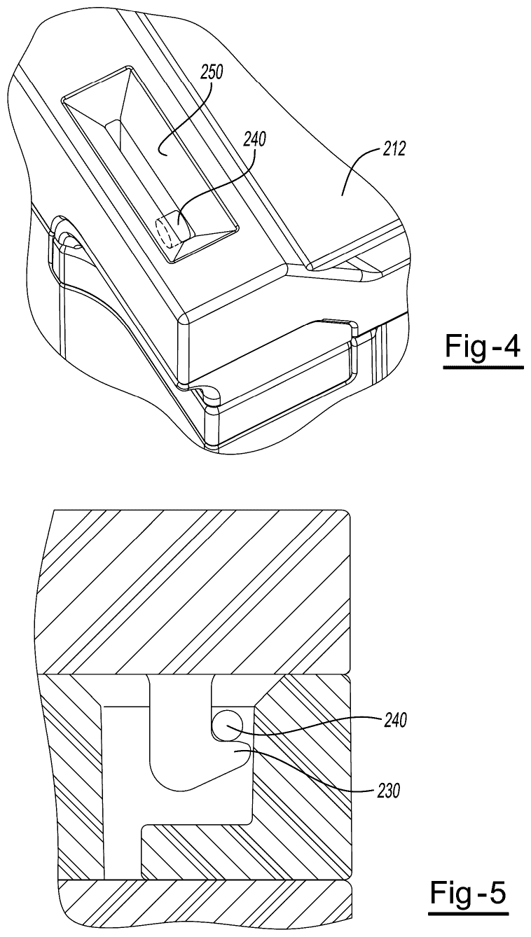

FIG. 3 depicts a perspective of the table having hooks 230 removable from the cooler base according to one or more embodiments shown and described herein. FIG. 4 depicts the aperture for the hooks for the table as shown in FIG. 4 according to one or more embodiments shown and described herein. FIG. 5 depicts a perspective view of the spring-loaded clips according to one or more embodiments shown and described herein. The 230 on the bottom of the tabletop 212 hook onto the 4 pins 240 in the openings 250 in the large lid. Spring loaded clips snap over the edge of the lid holding the table top in a locked mode. The drain hole hidden in lock indent prevents water from pooling in the slot openings.

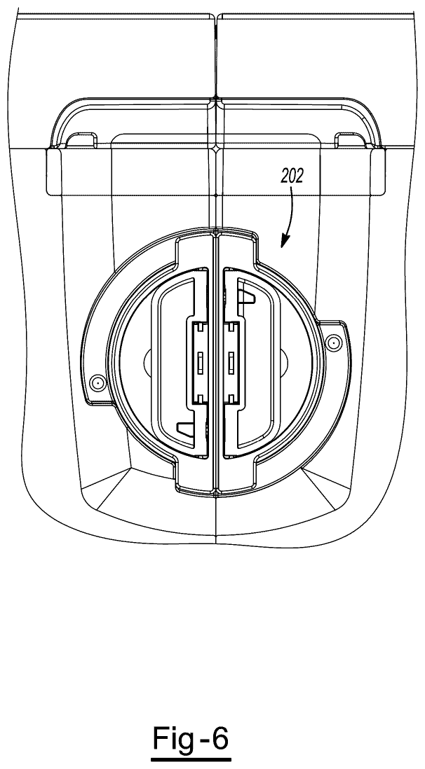

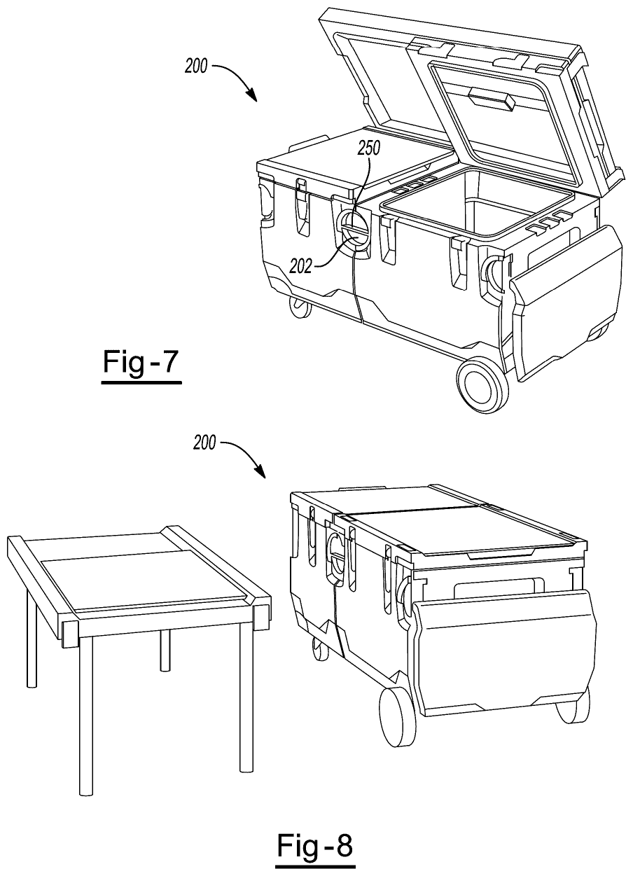

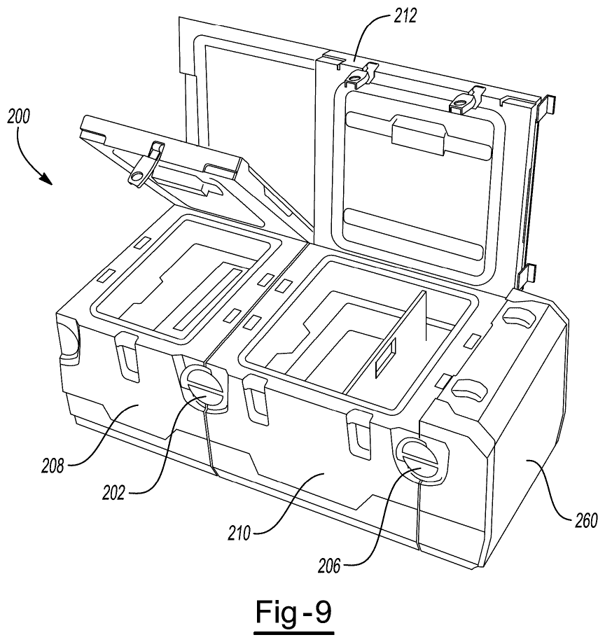

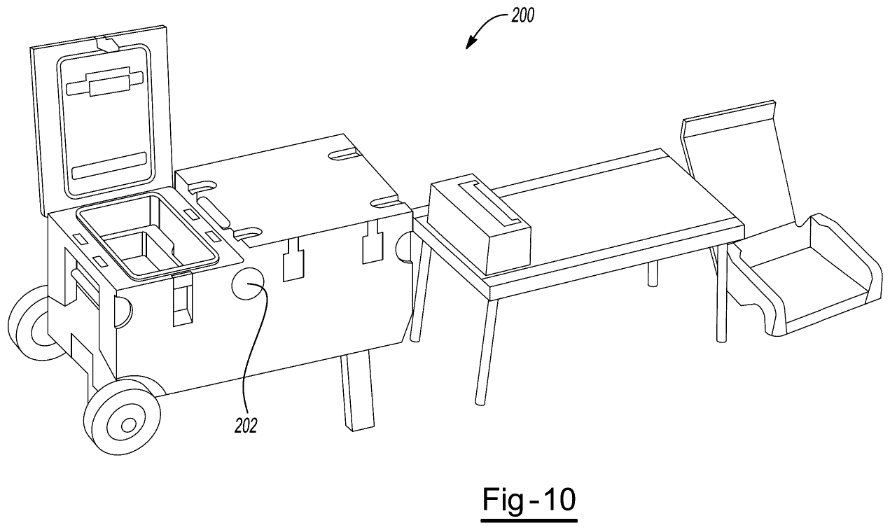

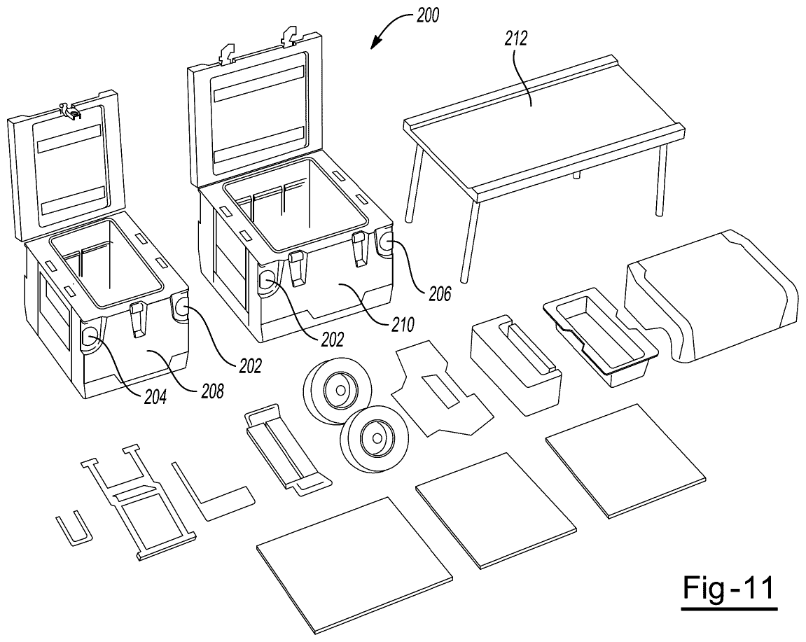

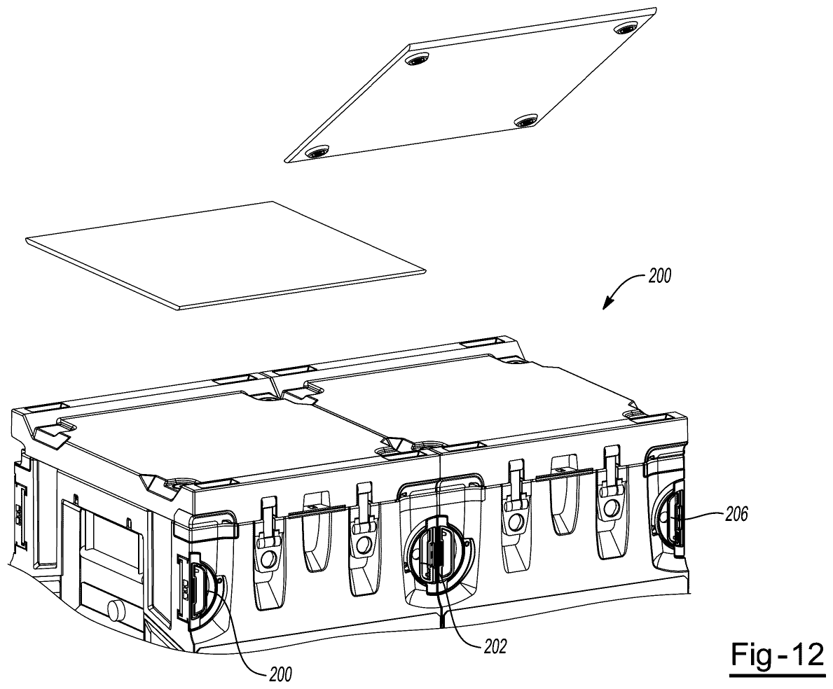

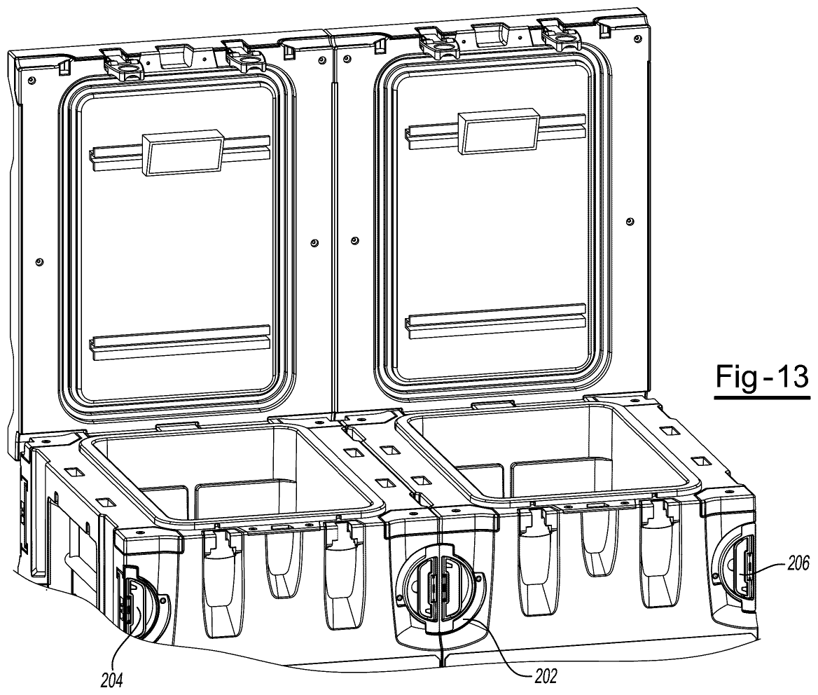

FIG. 6 depicts a perspective view of the dial cooler according to one or more embodiments shown and described herein. FIG. 7 depicts a perspective view of the dial cooler according to one or more embodiments shown and described herein. FIG. 8 depicts a perspective view of the dial cooler according to one or more embodiments shown and described herein. FIG. 9 depicts an exploded perspective view of one embodiment of the dial cooler according to one or more embodiments shown and described herein. FIG. 10 depicts an exploded perspective view of one embodiment of the dial cooler according to one or more embodiments shown and described herein. FIG. 11 depicts an exploded perspective view of one embodiment of the dial cooler according to one or more embodiments shown and described herein. FIG. 12 depicts an exploded perspective view of one embodiment of the dial cooler according to one or more embodiments shown and described herein. FIG. 13 depicts a dial embodiment cooler with a set of rails on the underside of the lids to allow quick attachment (and detachment of accessories) according to one or more embodiments shown and described herein. The rotating dial 202 includes a handle or grip portion 250 allowing the user to rotate the dial 202 to unlatch the assembly 200 to allow the components 208, 210 to separate from one another. An endcap 260 may be provided connected to an end portion of one of the cooler slash storage components 210. The endcap may be used to store any other items, maybe insulated or not, usable to the user of the assembly 200.

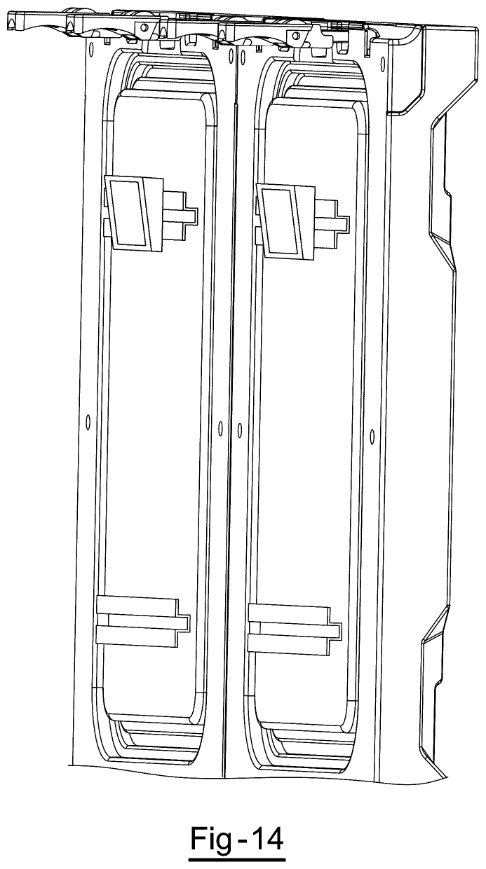

FIG. 14 depicts a dial embodiment cooler with a set of rails on the underside of the lids to allow quick attachment (and detachment of accessories) according to one or more embodiments shown and described herein. A set of rails on the underside of the lids allow a user to quickly attach and detach accessories like LED lights, storage bags, ice packs . . . etc.

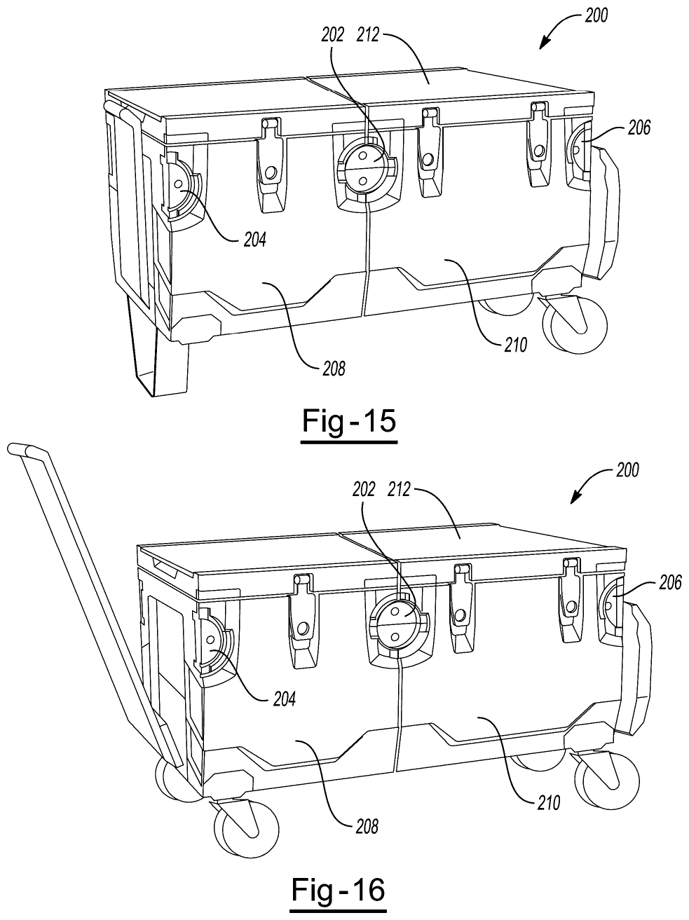

FIG. 15 depicts a perspective view of the dial embodiment cooler with wheels and a prop leg according to one or more embodiments shown and described herein. FIG. 16 depicts a perspective view of the dial embodiment cooler with wheels according to one or more embodiments shown and described herein. With a full 360° swivel attached to the bottom of the assembly 200 through a rubber foot assembly. A user can attach two wheels on one side with a prop leg bracket on the other side to keep the cooler level. Alternatively, the user can attach four of the same swivel wheels with the rear wheels located to hold position and not swivel.

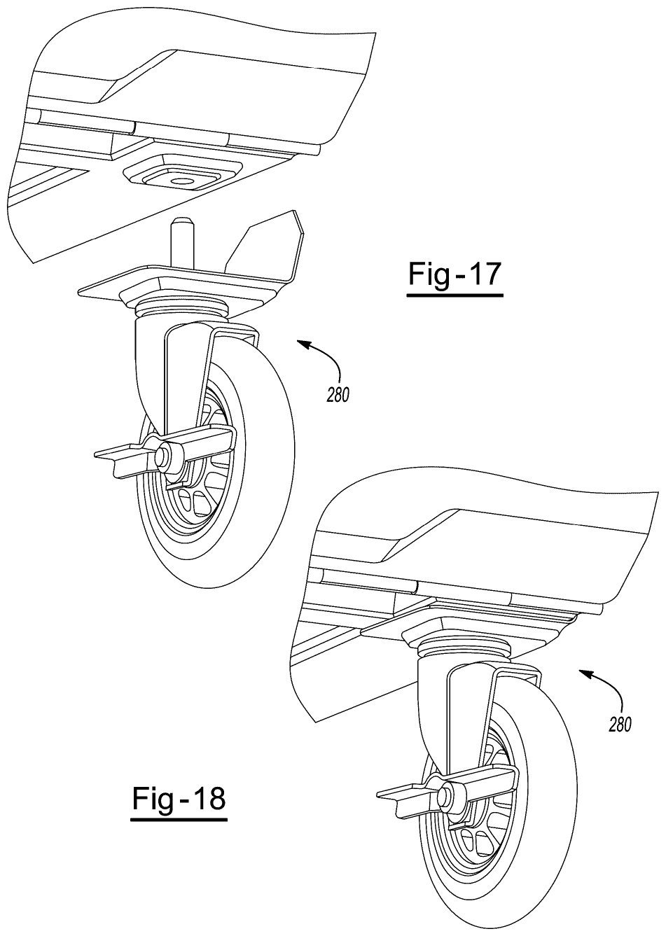

FIG. 17 depicts a close-up perspective view of the wheel 280 detached according to one or more embodiments shown and described herein. FIG. 18 depicts a close-up perspective view of the wheel attached according to one or more embodiments shown and described herein. Each bracket has a large pin that locates inside a hole through the bottom rubber foot and locks in place.

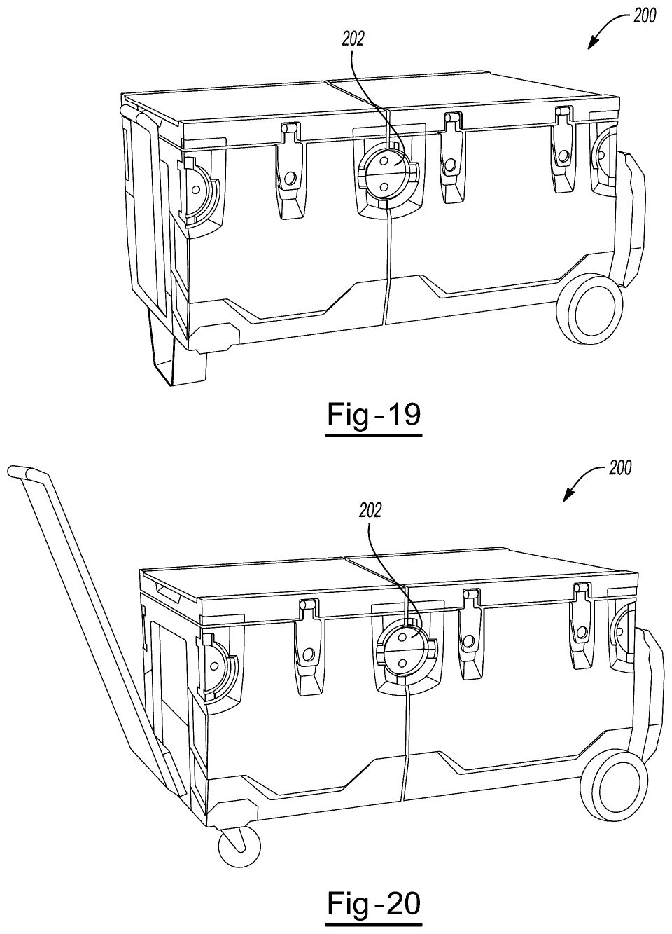

FIG. 19 depicts an embodiment of the cooler with stationary wheels and a fixed prop leg according to one or more embodiments shown and described herein. FIG. 20 depicts a perspective view of a cooler with 4 wheels differing in size according to one or more embodiments shown and described herein. Wheel configuration is 2 fixed, stationary wheels with a prop leg bracket. Alternatively, two stationary fixed wheels and two smaller full swivel wheels.

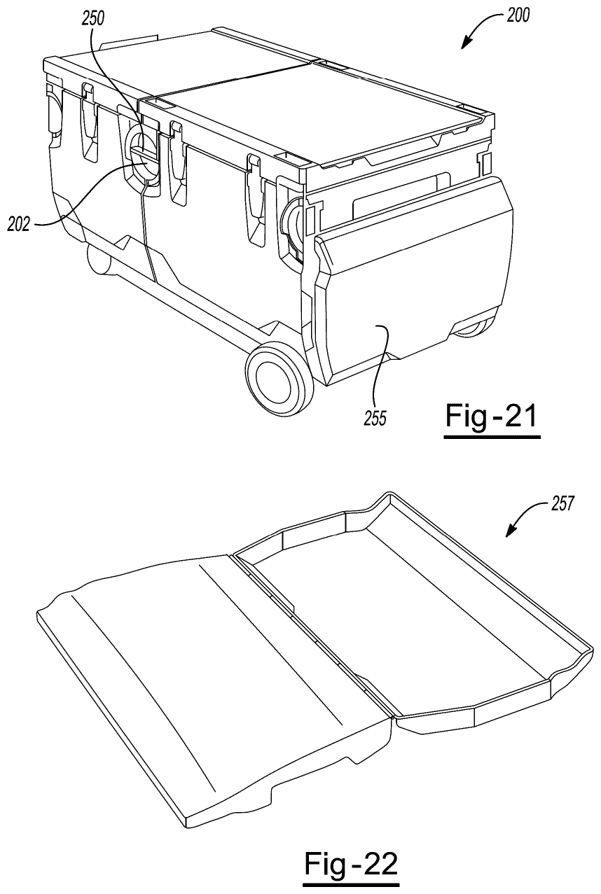

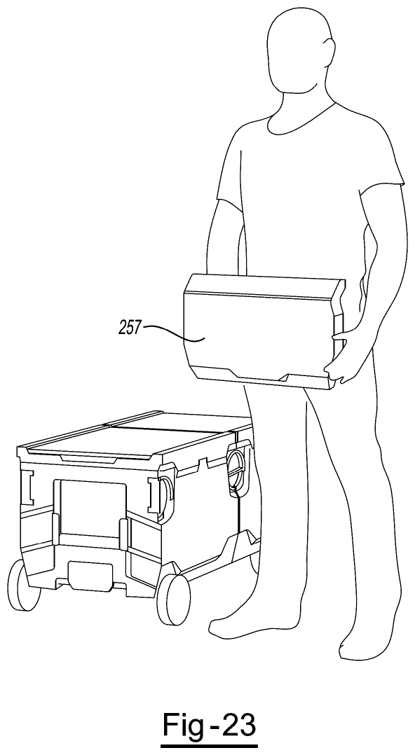

FIG. 21 depicts a perspective view of a cooler with an endcap case 255 connected thereto according to one or more embodiments shown and described herein. FIG. 22 depicts a perspective view of the endcap only interior 257 according to one or more embodiments shown and described herein. FIG. 23 depicts a perspective view of a cooler with an endcap case connected thereto according to one or more embodiments shown and described herein. The end cap 255 fits onto either side of the main cooler unit. The base case can accommodate any number of functions: general storage, fishing pole holder, backup battery, stereo speakers, propane camp stove . . . etc.

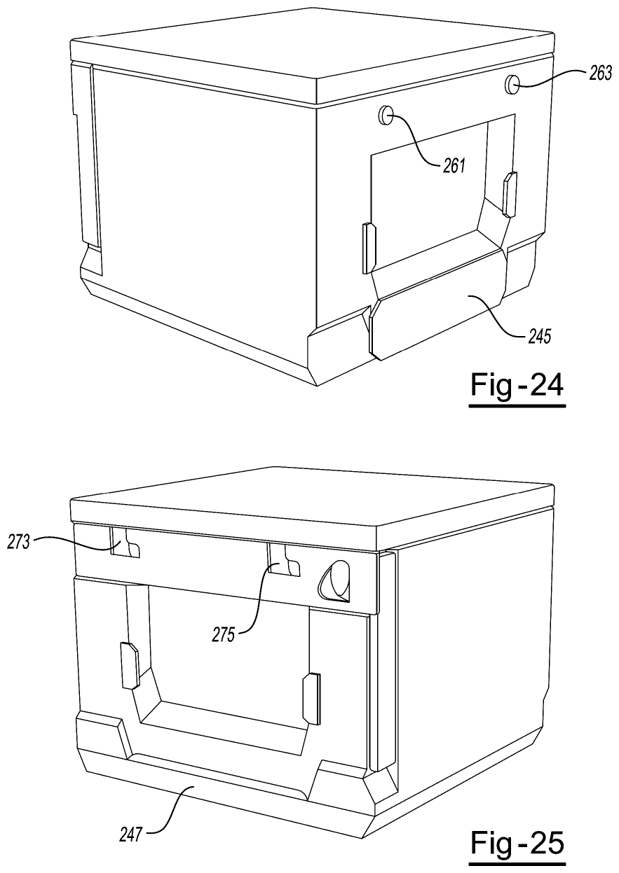

FIG. 24 depicts a perspective view of a cooler of the present application having a base plate connection method according to one or more embodiments shown and described herein. FIG. 25 depicts a perspective view of a cooler of the present application having a base plate connection method according to one or more embodiments shown and described herein.

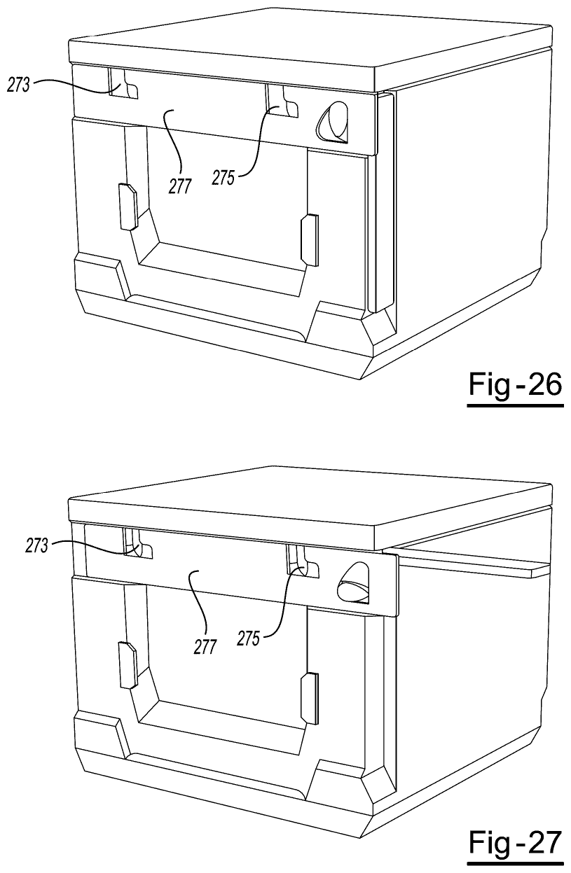

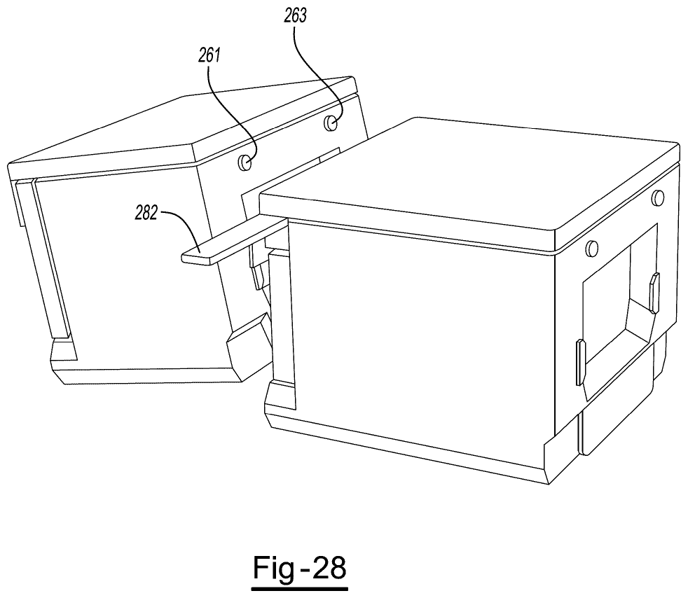

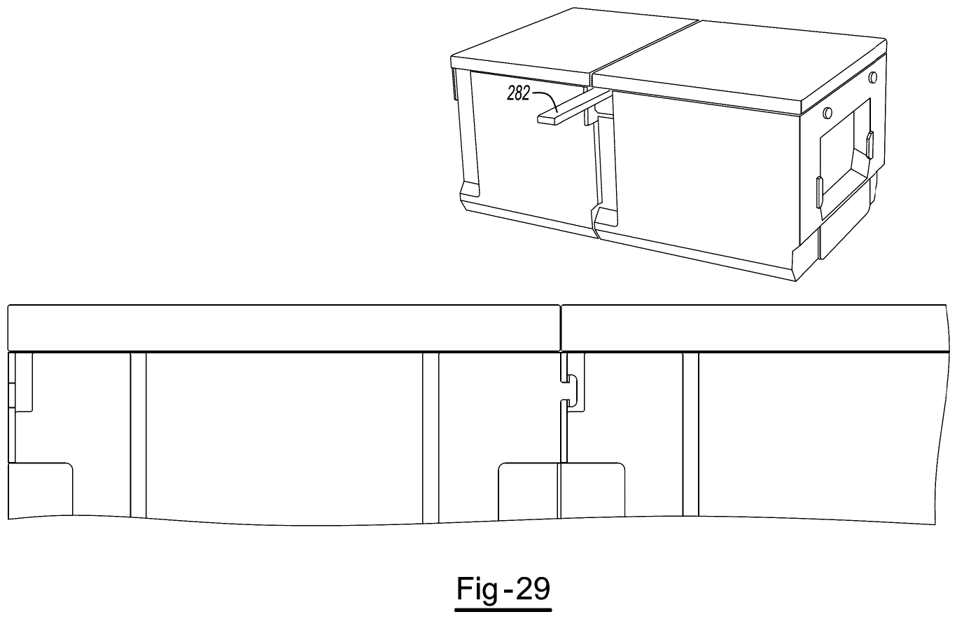

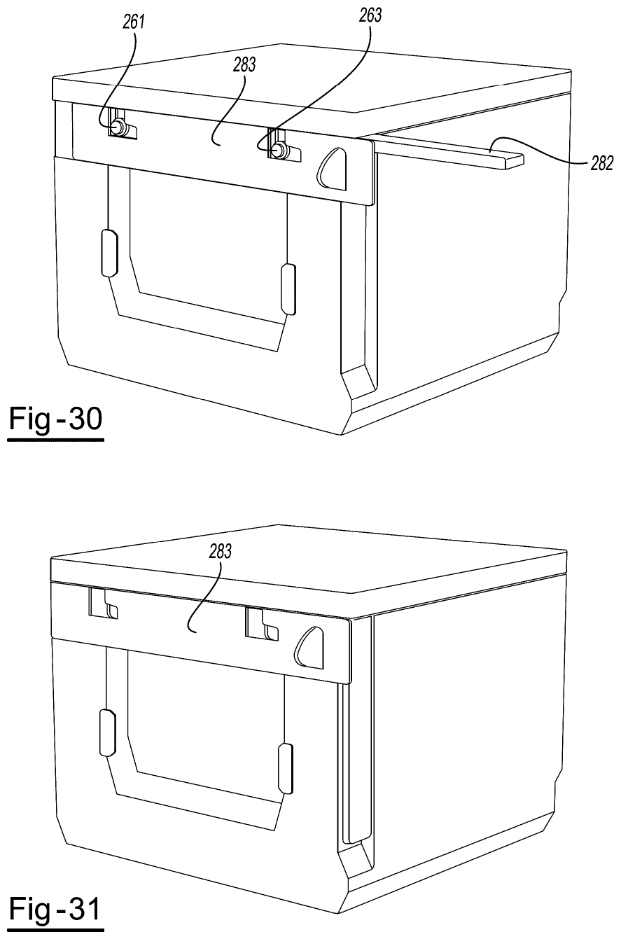

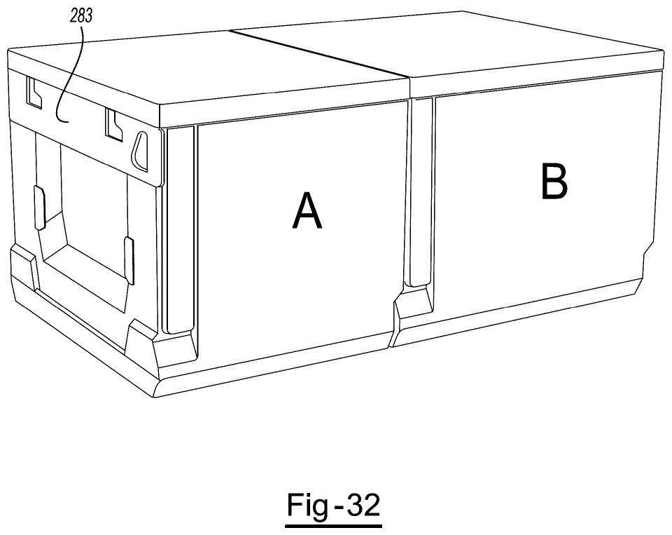

FIG. 26 depicts a perspective view of a cooler of the present application having a base plate connection method according to one or more embodiments shown and described herein. FIG. 27 depicts a perspective view of a cooler of the present application having a base plate connection method according to one or more embodiments shown and described herein. FIG. 28 depicts a perspective view of a cooler of the present application having a base plate connection method according to one or more embodiments shown and described herein. FIG. 29 depicts a perspective view of a cooler of the present application having a base plate connection method using metal lugs on the right side according to one or more embodiments shown and described herein. FIG. 30 depicts a perspective view of a cooler of the present application having a base plate connection method using metal lugs on the right side according to one or more embodiments shown and described herein. FIG. 31 depicts a perspective view of a cooler of the present application having a base plate connection method using metal lugs on the right side according to one or more embodiments shown and described herein. FIG. 32 depicts a perspective view of a cooler of the present application having a base plate connection method using metal lugs on the right side according to one or more embodiments shown and described herein. This concept utilizes the same base plate connection method for holding the bottom edges together as the first concept described herein. Pins 261, 263 are provided along with a base plate 245. A metal plate 277, 283 is also provided. Slots 273, 275 are configured to connect with the pins 261, 263. The metal plate 277, 283 is held in the closed mode under a spring tension. By lifting a lever 282 on the front of the unit, the plate 277, 283 slides forward to open the lock zones and slots 273, 275. When the second unit pivots into the position of the metal logs 261, 263 on the right side of the unit to locate into the open lock zone slots 273, 275. When the second unit pivots into position, the metal lugs 261, 263 on the right side of the unit locate into the open lock zone slots 273, 275. The logs 261, 263 are captured behind the metal plate 277, 283 when the handle 282 is folded down. The logs 261, 263 are captured behind the metal plate 277, 283 when the handle 282 is folded back down.

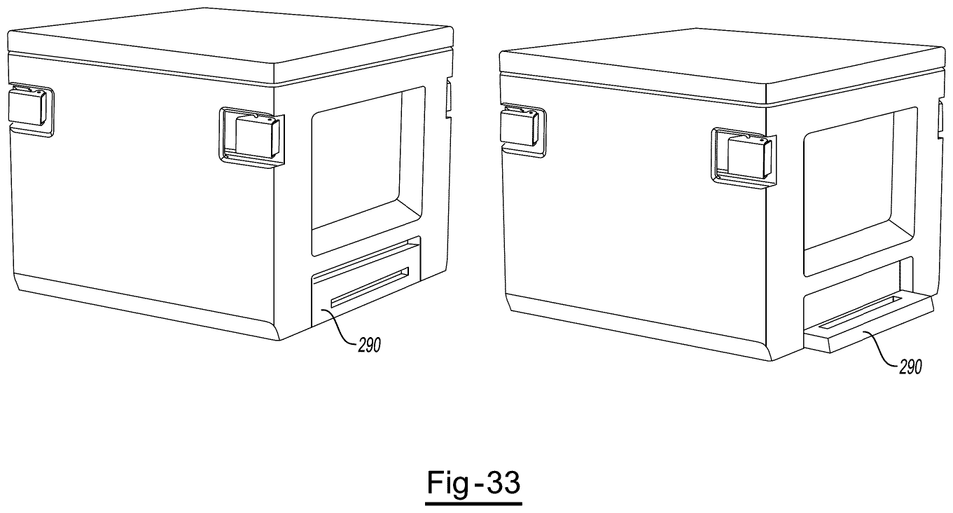

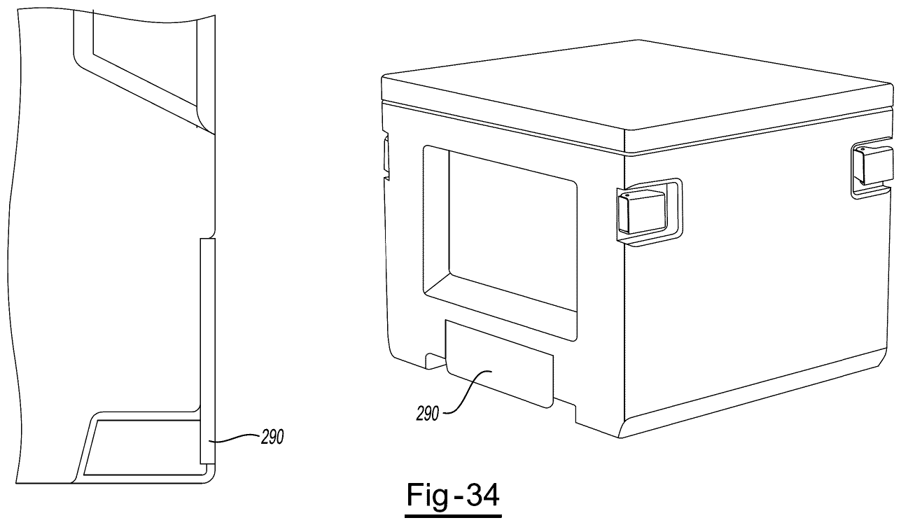

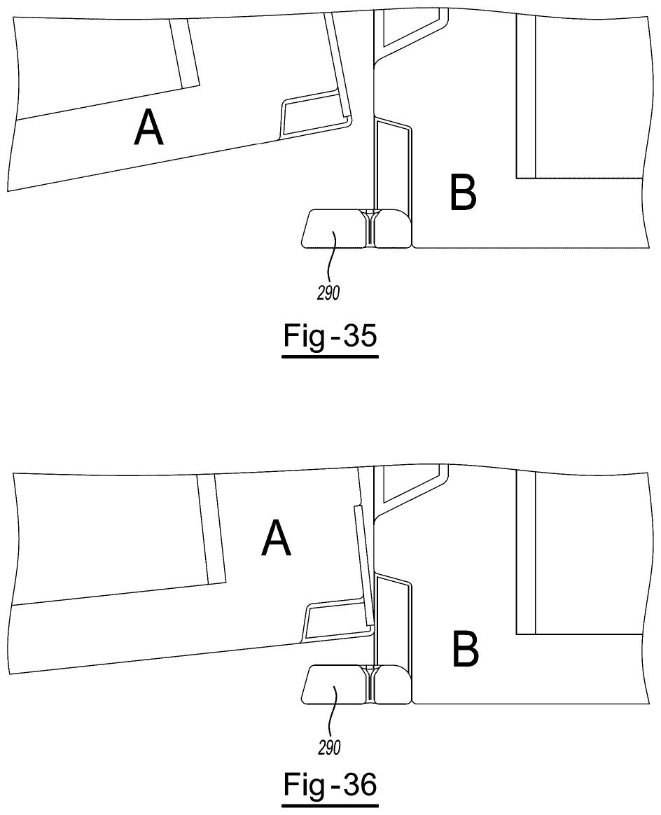

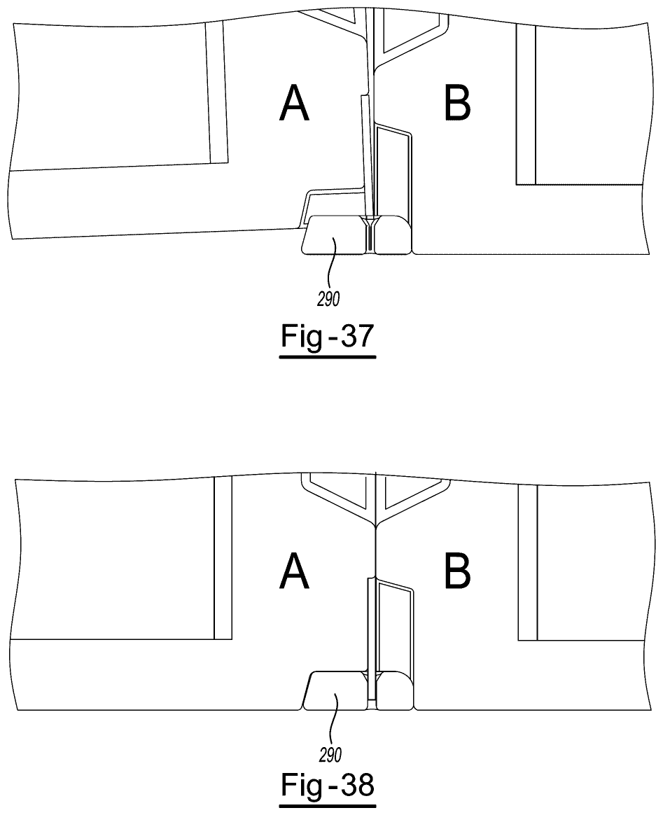

FIG. 33 depicts a perspective view of a cooler of the present application having a heavy duty panel base plate 290 for connecting the modular cooler portions according to one or more embodiments shown and described herein. FIG. 34 depicts a perspective view of a cooler of the present application having a heavy duty panel base plate 290 for connecting the modular cooler portions according to one or more embodiments shown and described herein. FIG. 35 depicts a side view of a cooler of the present application having a heavy duty panel base plate 290 for connecting the modular cooler portions according to one or more embodiments shown and described herein. FIG. 36 depicts a side view of a cooler of the present application having a heavy duty panel base plate 290 for connecting the modular cooler portions according to one or more embodiments shown and described herein. FIG. 37 depicts a side view of a cooler of the present application having a heavy duty panel base plate 290 for connecting the modular cooler portions according to one or more embodiments shown and described herein. FIG. 38 depicts a side view of a cooler of the present application having a heavy duty panel base plate 290 for connecting the modular cooler portions according to one or more embodiments shown and described herein. A heavy duty panel base plate 290 on the right side folds down. When not in use, the feature is flush with the side wall. On the left side, a heavy metal plate is attached, flush to the side wall. The metal plate on the left side fits inside the panel on the right and the bottom edges are fixed together. The metal plate on the left side, fits inside the panel on the right and the bottom edges are fixed together. The metal plate on the left side fits inside the panel on the right and the bottom edges are fixed together. The metal plate on the left side fits inside the panel on the right and the bottom edges are fixed together. When the bottom edges are held together you must now latch the sides together.

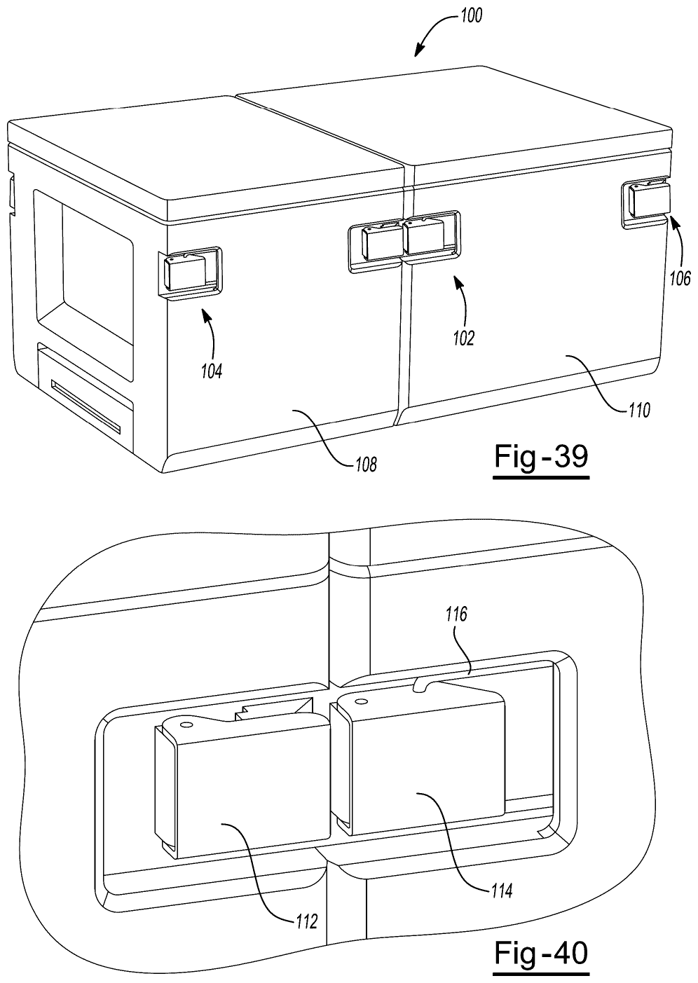

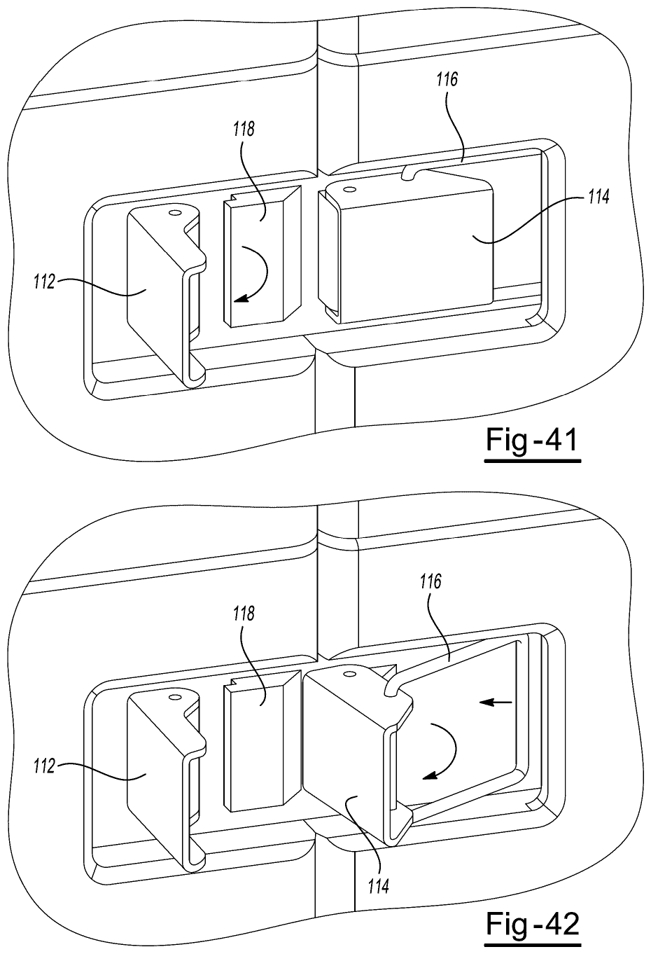

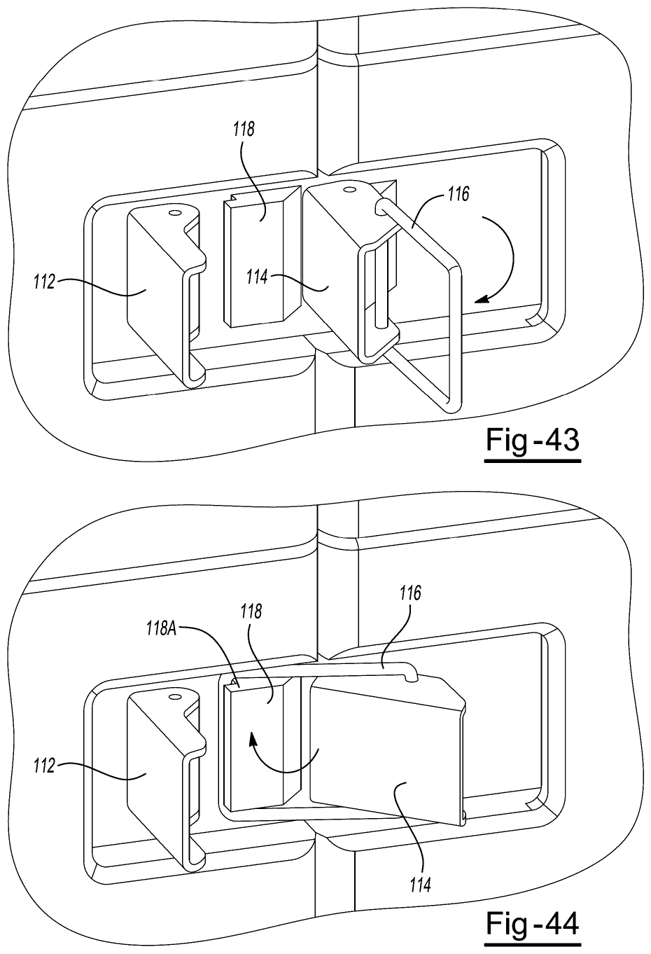

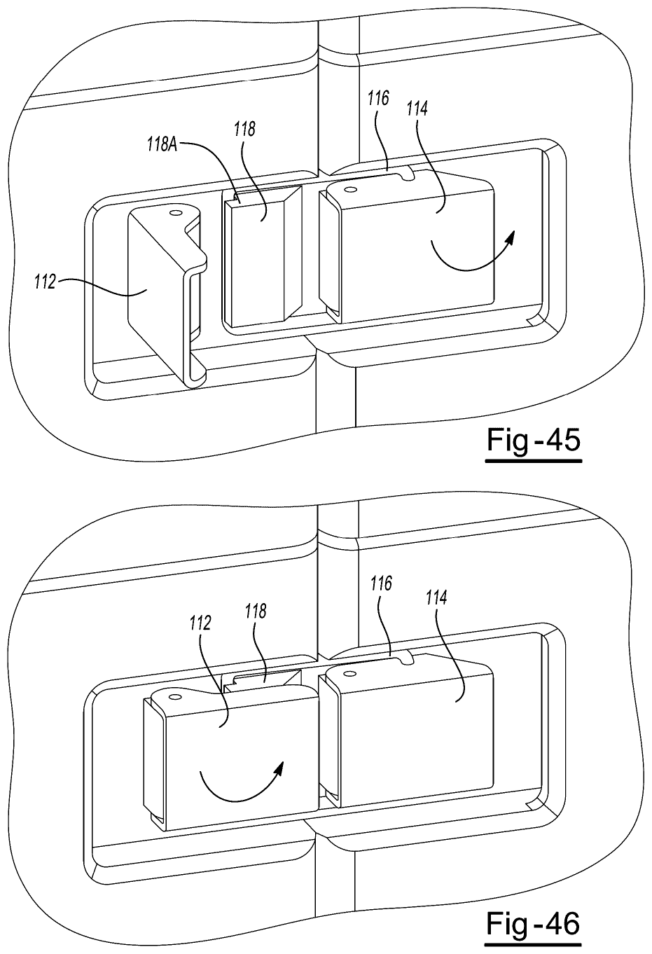

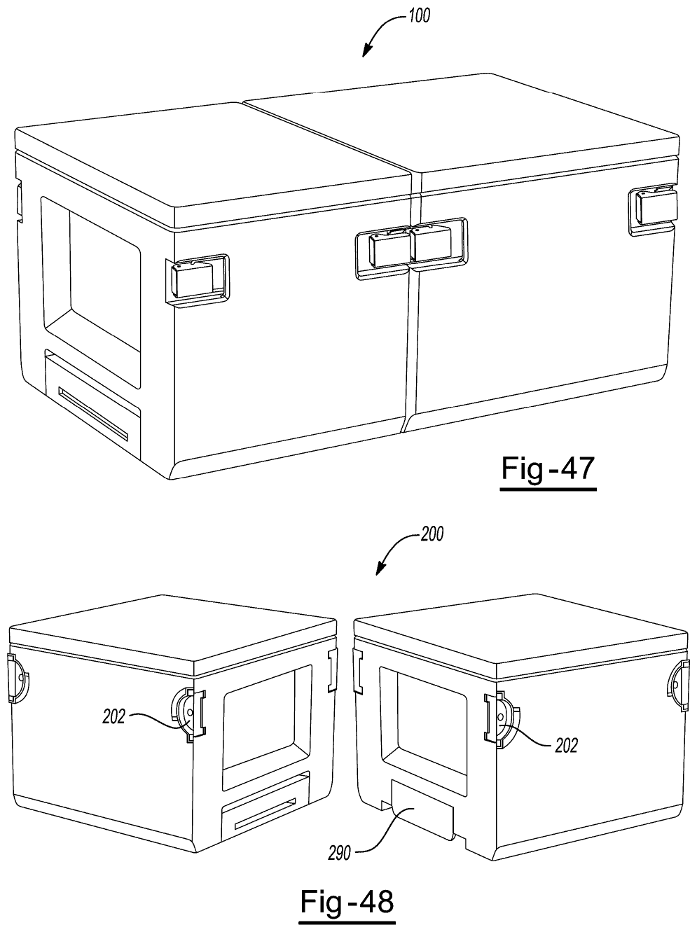

FIG. 39 depicts a perspective view of a cooler of the present application having a buckle connector connecting the modular cooler portions having a latch to secure the side of each cooler together according to one or more embodiments shown and described herein. FIG. 40 depicts a close up perspective view of a cooler of the present application having a buckle connector connecting the modular cooler portions in an unlatched position having a latch to secure the side of each cooler together according to one or more embodiments shown and described herein. FIG. 41 depicts a close up perspective view of a cooler of the present application having a buckle connector connecting the modular cooler portions in an unlatched position moving towards a latched position having a latch to secure the side of each cooler together according to one or more embodiments shown and described herein. FIG. 42 depicts a close up perspective view of a cooler of the present application having a buckle connector connecting the modular cooler portions in an unlatched position moving towards a latched position having a latch to secure the side of each cooler together according to one or more embodiments shown and described herein. FIG. 43 depicts a close up perspective view of a cooler of the present application having a buckle connector connecting the modular cooler portions in an unlatched position moving towards a latched position having a latch to secure the side of each cooler together according to one or more embodiments shown and described herein. FIG. 44 depicts a close up perspective view of a cooler of the present application having a buckle connector connecting the modular cooler portions in an partially latched position having a latch to secure the side of each cooler together according to one or more embodiments shown and described herein. FIG. 45 depicts a close up perspective view of a cooler of the present application having a buckle connector connecting the modular cooler portions in an partially latched position having a latch to secure the side of each cooler together according to one or more embodiments shown and described herein. FIG. 46 depicts a close up perspective view of a cooler of the present application having a buckle connector connecting the modular cooler portions in an latched position having a latch to secure the side of each cooler together according to one or more embodiments shown and described herein. FIG. 47 depicts a perspective view of a cooler of the present application having buckle latch for connecting the modular cooler portions having a latch to secure the side of each cooler together according to one or more embodiments shown and described herein. FIGS. 39-47 illustrate a buckle latch cooler slash storage assembly 100 having a buckle latch 102, 104, 106. Cooler slash storage compartments 108, 110 are provided connected together by the buckle latch 102. Each buckle latch 102 includes a first buckle 112 and a second buckle 114. The second buckle 114 is connected to a wire form 116 and is pivotable with respect to the second buckle 114. To latch the assembly, a user opens the second latch to pull the wire form 116 out from the stowed pocket. The user then swings the wire form 116 over to the opposite side towards the first latch 112. The user then sets the wire form 116 behind the locking edge 118A of the block 118. The user then returns the second latch 114 back to its first position to secure the latch and the wire form 116. The user then closes the first latch 112, or latch cover, to cover the block 118.

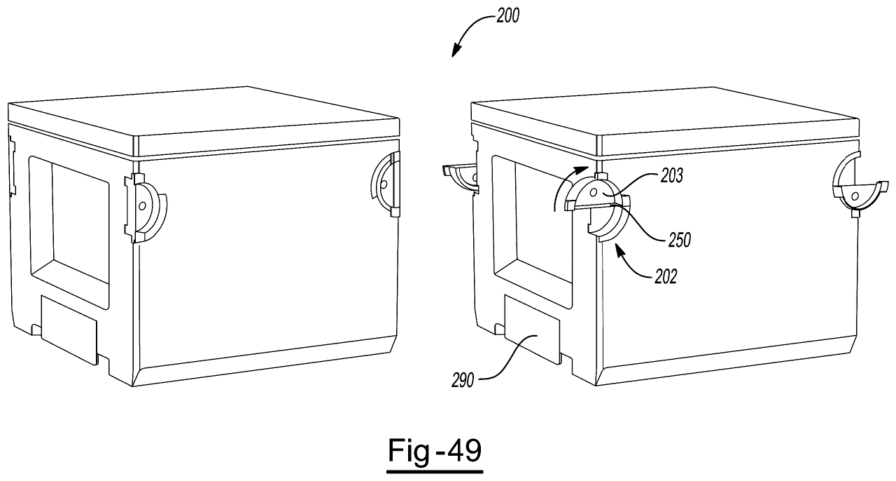

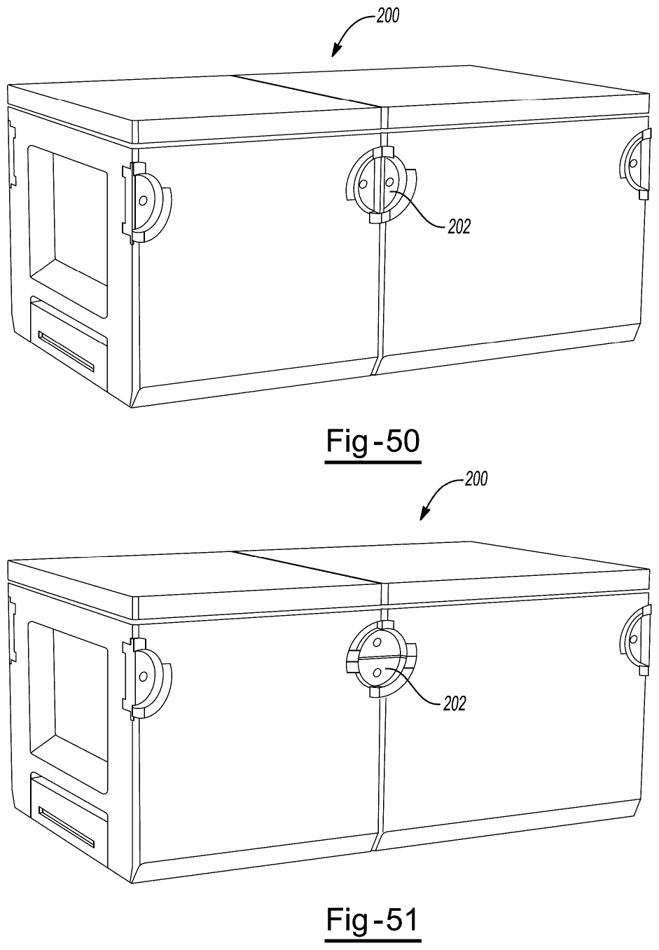

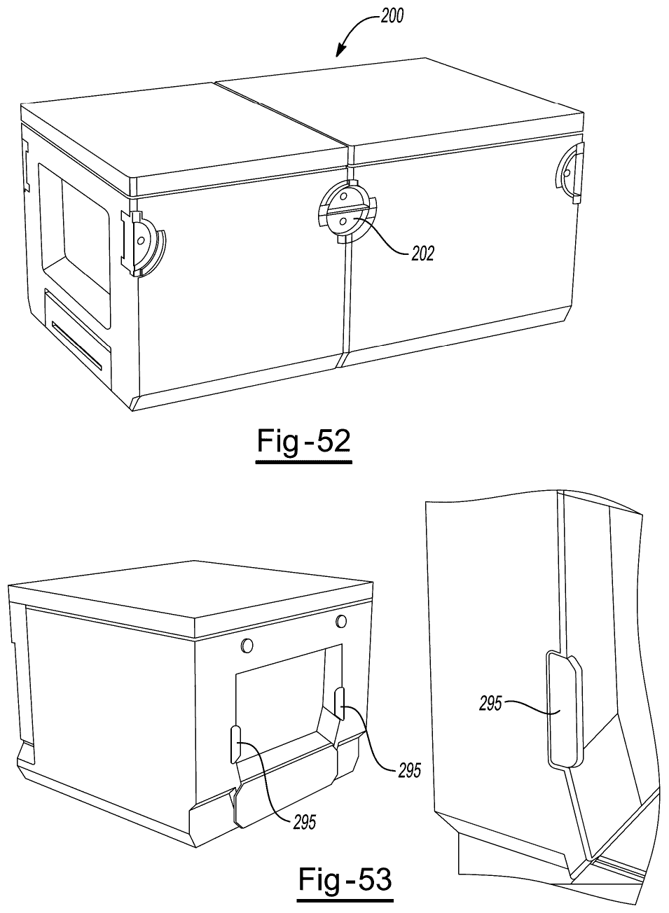

FIG. 48 depicts a perspective view of a cooler of the present application having rotating dial latch for connecting the modular cooler portions having a latch to secure the side of each cooler together according to one or more embodiments shown and described herein. FIG. 49 depicts a partially exploded perspective view of a cooler of the present application having rotating dial latch for connecting the modular cooler portions having a latch to secure the side of each cooler together according to one or more embodiments shown and described herein. FIG. 50 depicts a perspective view of a cooler of the present application having rotating dial latch for connecting the modular cooler portions having a latch to secure the side of each cooler together according to one or more embodiments shown and described herein. FIG. 51 depicts a perspective view of a cooler of the present application having rotating dial latch for connecting the modular cooler portions having a latch to secure the side of each cooler together according to one or more embodiments shown and described herein. FIG. 52 depicts a perspective view of a cooler of the present application having rotating dial latch for connecting the modular cooler portions having a latch to secure the side of each cooler together according to one or more embodiments shown and described herein;

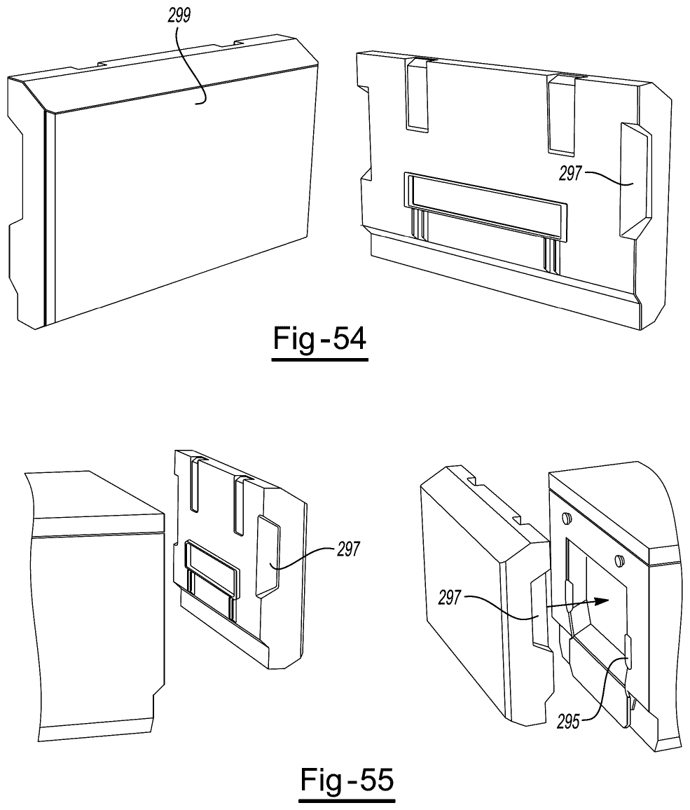

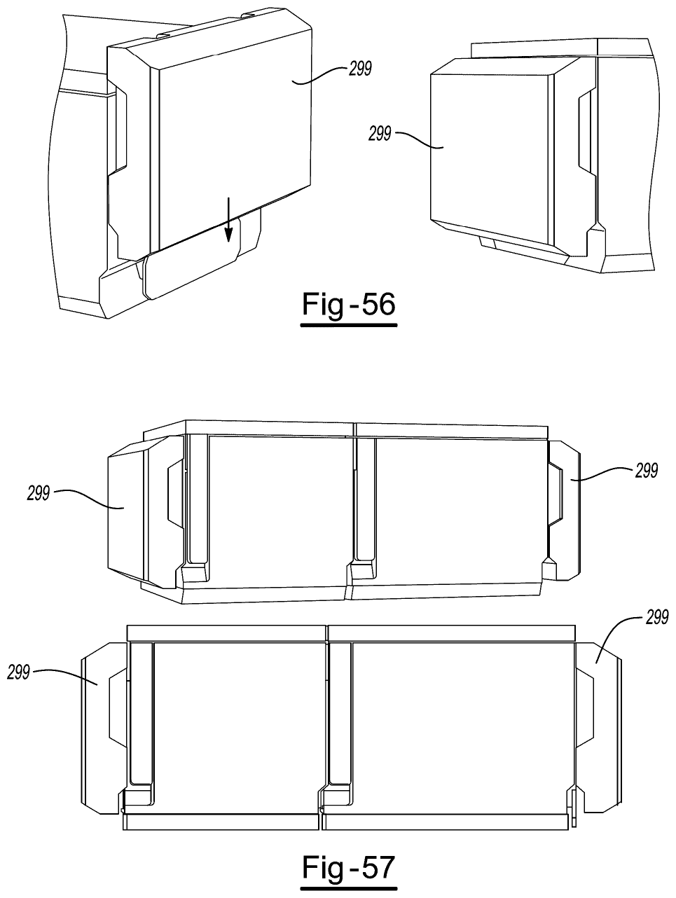

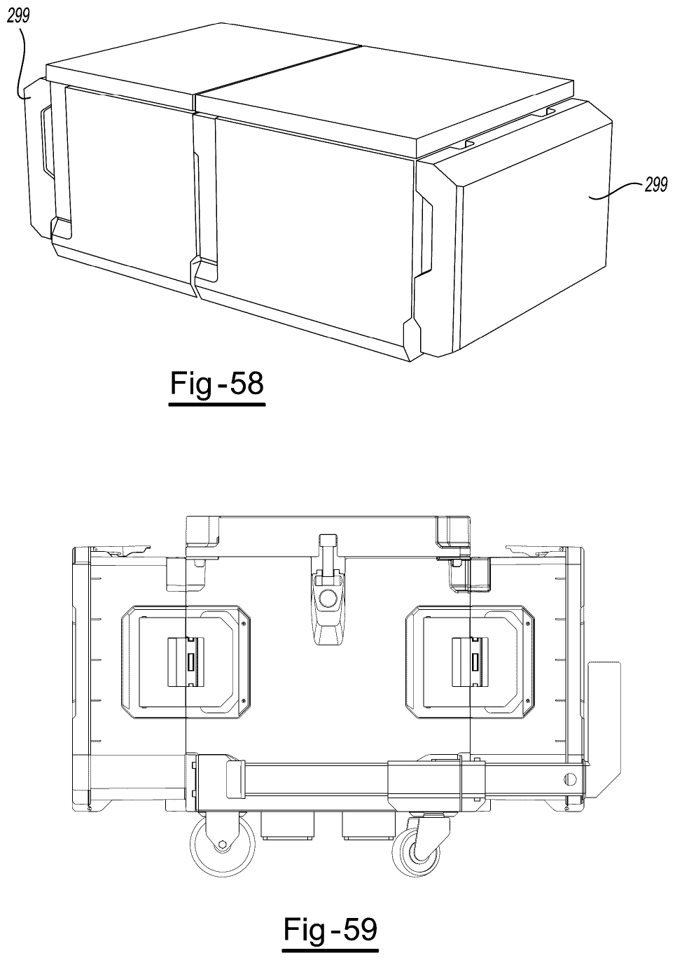

FIG. 53 depicts a perspective view of a cooler of the present application having an end cap for connecting to the modular cooler portions having a latch to secure the side of each cooler together according to one or more embodiments shown and described herein. FIG. 54 depicts a perspective view of a cooler of the present application having an end cap for connecting to the modular cooler portions having a latch to secure the side of each cooler together according to one or more embodiments shown and described herein. FIG. 55 depicts a perspective view of a cooler of the present application having an end cap for connecting to the modular cooler portions having a latch to secure the side of each cooler together according to one or more embodiments shown and described herein. FIG. 56 depicts a perspective view of a cooler of the present application having an end cap for connecting to the modular cooler portions having a latch to secure the side of each cooler together according to one or more embodiments shown and described herein. FIG. 57 depicts a perspective view of a cooler of the present application having an end cap for connecting to the modular cooler portions having a latch to secure the side of each cooler together according to one or more embodiments shown and described herein. FIG. 58 depicts a perspective view of a cooler of the present application having an end cap for connecting to the modular cooler portions having a latch to secure the side of each cooler together according to one or more embodiments shown and described herein. Two small brackets 295 attach to the open zone for the handle of the endcap 299. The end cap 299 has recessed grooves to allow the straps of the handle to fit through and to the outside period bracket tabs on the backside for holding the unit in position period the bracket tabs go inside the handle opening and drop down behind the brackets thereby securing it in position. The bracket tabs go inside the handle opening and drop down behind the brackets thereby securing it in position. The end caps 299 rust above the ground so that they are not load bearing, and are designed to not interfere with any of the existing hardware on the main unit 100, 200.

FIG. 59 depicts a front view of a modular cooler/storage system and assembly according to one or more embodiments shown and described herein.

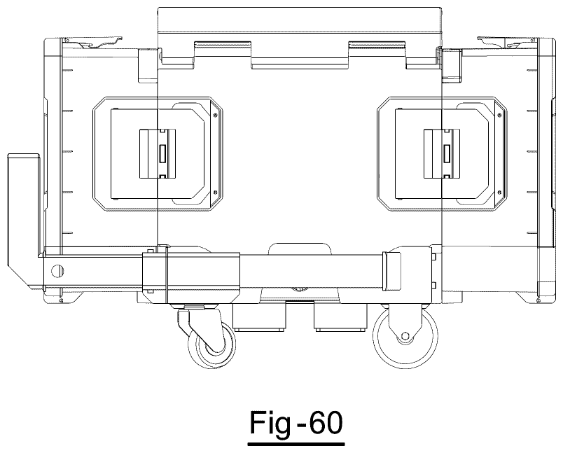

FIG. 60 depicts a front view of a modular cooler/storage system and assembly according to one or more embodiments shown and described herein.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of, or even consist of the elements, ingredients, components or steps.

Plural elements, ingredients, components, or steps can be provided by a single integrated element, ingredient, component or step. Alternatively, a single integrated element, ingredient, component, or step might be divided into separate plural elements, ingredients, components or steps. The disclosure of “a” or “one” to describe an element, ingredient, component, or step is not intended to foreclose additional elements, ingredients, components or steps. All references herein to elements or metals belonging to a certain group refer to the Periodic Table of the Elements published and copyrighted by CRC Press, Inc., 1989. Any reference to the group or groups shall be to the group or groups as reflected in this Periodic Table of the Elements using the IUPAC system for numbering groups.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims (and/or any future claims filed in any utility application) cover all such changes and modifications that are within the scope of the claimed subject matter.

Moreover, although various aspects of the claimed subject matter have been described herein, such aspects need not be utilized in combination.

It is therefore intended that the appended claims cover all such changes and modifications that are within the scope of the claimed subject matter.

1. A modular cooler assembly, comprising:
a plurality of cooler components, each cooler component defining an interior storage space and an exterior surface; and
at least one connector configured to removably interconnect adjacent cooler components, wherein the connector includes:
a first engagement portion attached to a first cooler component; and
a second engagement portion attached to a second cooler component;
wherein the plurality of cooler components are configured to be arranged in multiple configurations based on user preference while maintaining thermal insulation of the interior storage space of each cooler component.

2. The modular cooler assembly of claim 1, wherein the first engagement portion and the second engagement portion is a rotating member configured to pivot relative to the respective cooler component.

3. The modular cooler assembly of claim 2, wherein the rotating member includes a handle configured to facilitate manual rotation of the rotating member to engage or disengage the first and second engagement portions.

4. The modular cooler assembly of claim 3, wherein the handle is ergonomically shaped to enhance grip and ease of operation.

5. The modular cooler assembly of claim 1, further comprising a stabilizing plate connected to the bottom of the plurality of cooler components, the stabilizing plate configured to provide structural support and enhance stability when the cooler components are interconnected.

6. The modular cooler assembly of claim 1, wherein the first engagement portion and the second engagement portion together form a buckle-like latch configured to secure adjacent cooler components.

7. The modular cooler assembly of claim 6, wherein the buckle-like latch includes a release mechanism configured to allow selective disengagement of the first and second cooler components.

8. The modular cooler assembly of claim 1 where the cooler components are insulated.

9. The modular cooler assembly of claim 1 where the cooler components are not insulated.

10. A modular storage assembly, comprising:
a plurality of storage components, each storage component defining an interior storage space and having an exterior surface; and
at least one connector configured to removably interconnect adjacent storage components, wherein the connector includes:
a first engagement portion attached to a first storage component;
a second engagement portion attached to a second storage component; and
a rotating latch having a handle, the rotating latch being configured to pivot between a locked position, where the first and second engagement portions are secured together, and an unlocked position, where the first and second engagement portions are disengaged
wherein the plurality of storage components are configured to be arranged in multiple configurations based on user preference.

11. The modular storage assembly of claim 10 where the storage components are insulated.

12. The modular storage assembly of claim 1 where the storage components are not insulated.

13. A modular storage assembly, comprising:
a plurality of storage components, each storage component defining an interior storage space and having an exterior surface; and
at least one connector configured to removably interconnect adjacent storage components, wherein the connector includes:
a first engagement portion attached to a first storage component;
a second engagement portion attached to a second storage component; and
a buckle-like latch configured to secure the first and second engagement portions together;
wherein the plurality of storage components are configured to be arranged in multiple configurations based on user preference.

14. The modular storage assembly of claim 13 where the storage components are insulated.

15. The modular storage assembly of claim 13 where the storage components are not insulated.
